(19) United States
(12) Patent Application Publication
(10) Pub. No.: US 2003/0026460 A1
(43) Pub. Date: Feb. 6, 2003

(54) Method for producing a three-dimensional object which can be tactilely sensed, and the resultant object

(76) Inventors: Gary W. Conrad, Manhattan, KS (US); Nolan Riley, Park Hill, OK (US); Prasanth Reddy, Kansas City, KS (US); William B. Hudson, Mankato, MN (US); Marc D. Larsen, Overland Park, KS (US)

Correspondence Address: POLSINELLI SHALTON & WELTE, P.C., 700 W. 47TH STREET, SUITE 1000, KANSAS CITY, MO, 64112-1802, US

(21) Appl. No.: 10/189,861

(22) Filed: Jul. 8, 2002

Related U.S. Application Data
(63) Continuation-in-part of application No. 09/310,134, filed on May 12, 1999, now abandoned.

(51) Int. Cl. G06K 9/00

(52) U.S. Cl. 382/114

(57) ABSTRACT

The present invention is for a process that can transform a 2-dimensional rendering into a 3-dimensional physical object that can be perceived tactilely by blind or visually impaired people. The process converts a 2-dimensional image to an electronic format where each pixel has an x, y, and z value. The image is then converted to a 3-dimensional form.

This application is a continuation-in-part of patent application Ser. No. 09/310,134, filed on May 12, 1999.

### FIELD OF INVENTION

The present invention relates to a method for converting 2-dimensional images into a 3-dimensional object that can be tactilely perceived. The invention further relates to the resultant 3-dimensional object and software for converting color or intensity to a third dimension.

### BACKGROUND OF THE INVENTION

The latest figures from the National Center of Health Statistics indicate that there are approximately 9 million Americans with severe visual impairments. This includes blind and visually impaired children and adults of various ages. Though the extent of visual impairment for these individuals varies, most cannot visually appreciate 2-dimensional artwork such as paintings, photographs, or drawings. In virtually all art museums, facilities or objects that convert the images of the paintings into a fonm that can be comprehended by blind and visually impaired people are not available. Thus, current art museums are only accessible to sighted people.

Braille is a practical, but relatively crude means by which blind and visually impaired people can read printed text that has been transformed into a 3-dimensional form that can be perceived by touch. Perception via touch is also referred to as a tactile sense. Unfortunately, Braille cannot be used to present images or pictures. For this reason, it is desired to have a method or member that allows images of paintings, drawings, photographs, or electronic images to be made available to tactile perception.

Currently, Braille represents the text of words that can be perceived tactilely by blind people, but a correspondingly standard process is unavailable for representing images. Known methods and objects typically contain only high-contrast outlines of the shapes of objects, not the intricate details of a work of art. What is desired is a method that allows for a 3-dimensional representation of artwork, including the various color intensities associated therewith. As such, it is desired to provide a more intricate rendition of the artwork or photos than what is currently available.

It has been known to use a deformable membrane applied directly to the surface of an object to form a member that can be tactilely sensed. Such method and device is not suited for use with 2-dimensional artwork. As can be seen, to deform the membrane, the object must already be of a 3-dimensional construction. Similarly, the use of embossed signs whose words can be read by sighted people and whose Braille-equivalent information can be read by visually handicapped people is not suited to produce images of paintings and drawings. Embossing does not provide sufficient tactile detail. Further, paintings cannot be embossed into a 3-dimensional form that can be tactilely sensed.

It has been known to symbolically encrypt color information from a painting; however, it is believed that encryption does not provide a suitable representation of artwork. The same can be said for a system of representing color using mixtures of parallel lines raised as ridges and inclined at different angles to one another to convey a sense of mixing three primary colors to produce any other color. It is desired to have a method and object for representing large, complex images, such as portraits and diagrams for tactile sensing.

Another known invention includes the use of a specific sheet material and method for use in converting a 2-dimensional image to a 3-dimensional image. The sheet is coated with an expandable material. An image is irradiated, which creates different temperatures on the image, based on the various colors. The heat or energy emanating from the image will be transferred to the sheet, whereby the sheet will raise to different heights according to the intensity of the heat. This method suffers from a lack of specificity. It is desired to have a more accurate method for producing a 3-dimensional object.

As such, it is desired to have a method and member, whereby a 2-dimensional image is converted to a 3-dimensional image that can be sensed tactilely. It is especially desired to have a method, which can be used to produce a member that includes the nuances of a painting or photo. It is desired to have a process by which a digitized image is transformed, refined, and manipulated to produce a 3-dimensional model.

### SUMMARY OF INVENTION

The present invention relates to a method for transforming 2-dimensional images into 3-dimensional, physical objects that can be perceived tactilely. Additionally, 3-dimensional renditions can be converted to 3-dimensional objects more suited to tactile perception. As such, the present invention is well suited for use by blind or visually impaired people.

The present invention relates to a process for transforming a 2-dimensional image into a 3-dimensional physical object that can be perceived tactilely. The method includes digitizing the image or converting the image to an electronic format. The image will be formed from a plurality of pixels which have x and y coordinates. The digitized image can then be converted to a gray map extension, also known as gray scale. Each pixel is assigned a gray level. Software is then used to assign an x, y, and z value to each pixel, with z related to the gray intensity and the height. A 3-dimensional structure is formed from the gray map extension. Thus, the gray scale step includes assigning all pixels, which form the image, a gray scale level and assigning a height to each pixel, based on the gray scale. The pixels can be smoothed to lessen contrast and peaks. Smoothing involves averaging pixels proximal to each other. The z value represents height or depth. Thus, each pixel has a gray value which corresponds to the z value.

A 3-dimensional object is formed from the method. The object includes a surface of varied height. The height or depth corresponds to a gray scale value. The member can be made from any of a variety of materials. Importantly, a member is produced that is a fairly accurate re-creation of a 2-dimensional image. Fabrication from durable plastic, ceramic, or metal composite or single component materials is can be used to form the 3-dimensional object. The resultant product can be of a permanent or temporary construction.

A software program for converting color intensity in a 2-dimensional image can be used. Again, an image can be converted to a 3-dimensional object. In particular, the invention relates to software for converting gray intensity to height.

The method includes reducing the 2-dimensional image to an electronic format. Using a computer program, the image is altered to allow for 3-dimensional production. A mold is then derived from the electronically altered image. The 3-dimensional member can be formed by a variety of methods. The technique can produce 3-dimensional media very rapidly, ideally in matters of minutes, depending upon the type of media being used. For example, techniques resembling embossing can be used. Deformable film media, such as paper, plastic, or rubber sheeting, or metal foil can be deformed and rendered hardened and rigidified. Rapid prototyping can be used to render the image in 3-dimensional form as fashioned on the surface of a block of metal, plastic, ceramic, or glass, as either a “positive,” raised, or relief, image, or as a “negative,” depressed, sunken, or engraved, image.

Advantageously, physical contact with the work of art being represented is not required. The method can be used to represent paintings, drawings, diagrams, or even printed text. As such, a rendition technique is practiced that can be used to represent images that are in black and white form, or in colored form, and automatically convert them into 3-dimensional digitized representations that are then converted to corresponding heights or depths in the physical media produced.

All applications can be portrayed as “positive,” raised, or relief images, or as “negative,” engraved, sunken, depressed, or cutout images, as in a mold or bowl form. Such negative images can be used to generate forms made of rubber to create flexible negative molds that can be used repeatedly for preparing “positive” casts.

### BRIEF DESCRIPTION OF THE DRAWINGS

FIG. 1 is a flowchart showing steps practiced in accordance with the present invention.

### DETAILED DESCRIPTION

The present invention relates to a process for converting a 2-dimensional member into a 3-dimensional physical representation that can be tactilely sensed. The present invention also relates to the resultant 3-dimensional representation. Additionally, the present invention relates to a computer program for converting color density or gray scale value to a z value which corresponds to a third dimension, height or depth.

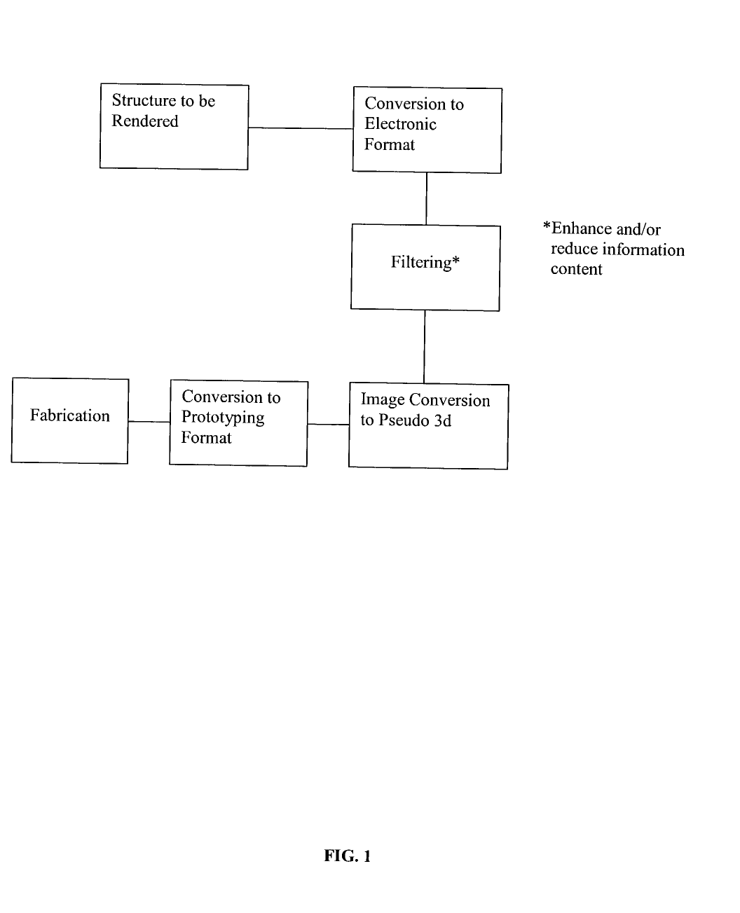

The preferred process is illustrated by the steps shown in FIG. 1. The method includes capturing and converting an image or picture to a digital or electronic format. Conversion to electronic or digital format is necessary for conversion to gray scale. Also, when the picture is digitized, it will be divided into a plurality of pixels, so that the picture is essentially defined by a plurality of points. The image in the digital format is converted to gray scale, which is a system whereby the picture is converted to a black and white image. The particular intensity of the gray scale will cause each pixel to be converted to the z scale (height or depth) in the 3-dimensional version. Essentially, a point cloud is produced, which can be translated into a 3-dimensional object.

The rendering or image to be converted can be a 2-dimensional image or a 3-dimensional object, with the 2-dimensional image preferred. An image includes any picture, painting, photo, drawing, or other 2-dimensional representation. The process of converting the image into an electronic format is initiated by producing an image of the rendering or artwork. As such, an image or photo is taken of a painting, for example. Another example of the image conversion involves obtaining a 35 mm photograph of the rendering followed by electronically scanning the slide. The image is preferably produced with a camera; however, a scanner, or other measuring system or device can be used. Regardless of the device selected, an image is captured that can be converted to a digitized format. Any device can be used to capture the image, as long as the resultant image can be digitized. The image is typically captured from one angle, looking at the picture or drawing.

More particularly, the image can be captured using a variety of methods including, but not limited to, the scan of an existing photograph or slide transparency or diagram; the use of a digital camera; the use of film-based camera and scanning of the resultant photograph; generation of the image directly with the computer and software; or, use of a single camera capturing only a 2-dimensional image. Thus, the process begins by obtaining an image that is in a 2-dimensional format. The image can be in color or black and white. Ultimately, the image is used to develop a 3-dimensional structure corresponding to the 2-dimensional image. Color or black and white intensity corresponds to the z scale. After an image is obtained, it must be digitized or placed in an electronic format.

The image is converted to an electronic or digital format. Conversion to an electronic format can be achieved using a variety of available devices and methods, whereby the image is scanned for example. Once scanned or converted, the digital information is preferably converted to ASCII data in which x and y coordinates describe the location of each pixel in the 2-dimensional image. As such, the image is converted to a plurality of pixels. Thus, a data file can be created from the digitized image. The data file converts information from the digitized image to a format that can be later manipulated with a software program. The digitizing process is accomplished using a standard software program that is commercially available. The resultant digitized image corresponds to a checkerboard with each square (pixel) having a value or intensity. A pixel is a point in space that defines an area of an x and y coordinate.

Thus, the digitized image is manipulated with a computer program to convert the picture into a plurality of pixels. The pixel size can be varied in size, dependent upon the desired finished characteristics of the 3-dimensional object. Pixel size can be determined by setting x and y coordinates, and can be referred to as dots/inch.

Regardless of whether the initial image was in black and white, or in color, the image is converted to a gray scale image. Any of a variety of software programs commercially available can be used to convert the image to gray scale. Each pixel is assigned a gray scale value. The gray scale value for each pixel is used to assign a z coordinate which can translate to height or depth to each pixel. As such, the third dimension of the image is extracted from the 2-dimensional picture by using the gray value of the pixel to represent a height. The pixel value could represent a color or a gray scale value. The gray value translates to a three dimensional structure without having access to the actual height information.

The corresponding z coordinate expresses the density of the gray scale image at each pixel position. The z coordinate is perpendicular to x and y coordinates. The z can represent height or depth, with it referred to as height throughout.

The gray scale will set the gray value between 0 (black) and 255 (white) with various shades of gray assigned values in between 0 and 255. Such numbers are used only as reference points as any system for assigning gray intensity could be used. Using a software program based on the intensity of the gray value, a pixel z value will be assigned. The z will translate to height or depth. As such, the highest point can be black or white, dependent upon the desired outcome, with the opposite the base line or lowest point. This is how the third dimension is assigned. A point cloud is created where each point or pixel has an x, y, and z coordinate. The software program is important for converting gray scale to pixel height. An example of the program is included herein and labeled “Program 1”.

Optionally, the pixels or digitized image can be subjected to algorithms to reduce the level of detail or to “smooth” the picture. This is done to provide for a better translation of the image. The program will average pixels proximal to one another to “smooth” the scale. Smoothing can be done before or after the image is converted to gray scale.

After it is converted into an electronic file, including, but not limited to cropping to eliminate information outside of specified boundaries, the image can be altered, with the dynamic range of color and/or intensity information modified to fit the intended usage. Alteration of the edges of the image can be done to make the edges softer (made more gradual) or harder (made more abrupt). Adding or removing noise from the image can be accomplished by using mathematical filtering operations. Further, altering information content of the image (by data discarding or averaging) to allow the image complexity to be appropriate for the intended application; and, scaling of the image to allow either compression or expansion of the image to enlarge images with fine detail, such as fingerprints, can be done to allow tactile appreciation of the details.

The purpose of filtering is to prepare the image in such a way that when it is rendered into a physical article, it contains an appropriate amount of information with amplitude components appropriate for the tactile senses of those using the system. An example of one possible technique for filtering is shown in the software code listing provided in Program 1. Additional filtering and image enhancement can be accomplished using a commercially available program, such as PaintShop Pro®.

The total range of values possible for x, y, and z can all be set by the user so that, for example, the possible range of the z values can be made small if a 3-dimensional prototype, with only slight vertical elevation, is desired, or can be made as large as desired, if very prominent vertical relief is desired. The x and y dimensions can be set for eventually producing a prototype of approximately 8″×10″, or could be set in much larger dimensions, e.g., of several feet or meters, if desired.

Colors and intensities of these colors are used to achieve a 3-dimensional pixel-by-pixel representation of the image. Therefore, a single image is used, with a single point of reference, to achieve the 3-dimensional rendition. A mapping of color intensity to height for the 3-dimensional image rendering is used.

The output from the present process should be thought of as a point cloud. That is the checker board with a surface that is no longer flat. Each of the checker board squares is raised or lowered to a point that corresponds to the intensity of the color or the gray scale. This height or offset is adjustable depending on what the desired use of the piece will be.

After the image is manipulated and converted to a 3-dimensional model, it is ready to produce a physical representation. An example of one possible technique for image conversion to pseudo 3-dimensional is shown in the software code listing provided. If the initial file was created from a 3-dimensional object the depth information from the object may be retained or modified, depending upon the initial object and the intended purpose of the output.

Preferably, the smoothed and filtered ASCII data are converted to a form that allows the filtered and smoothed image to be viewed as a 3-dimensional image on a monitor. The image can be represented electronically as at least 3 types of images, each of which can be used to produce a corresponding physical representation. Available prototypes include a positive relief image, a negative relief image, and a double-sided positive and negative image.

The positive relief image means that in this type of presentation, the dark regions of the original image appear to be elevated above the flat background level of the surrounding image. In the negative relief image, the dark regions of the original image appear to be depressed below the flat background level of the surrounding image. In the double-sided positive and negative image, a positive relief image is created on one side of the image, and the corresponding negative relief image is created on the other side. Thus, a given region of the image will be represented in both positive and negative relief, simultaneously. When produced as a physical prototype, such a representation would allow a blind person to interact with the prototype with both hands, simultaneously.

Once the 2-dimensional object has been converted, it can be formed into a 3-dimensional form. This can be achieved with any of a variety of methods and processes. For example, the format can be converted to an STL format. One technique for converting the data file into the prototyping format utilizes the Surfacer® program, which is produced by Imageware. The 3-dimensional object can be made from any of a variety of materials. The object will have a surface that corresponds to an image. The surface will define x, y, and z coordinates, with the z coordinates varying. As such, the surface corresponds to a plurality of points having a defined x and y coordinate, with the z coordinate corresponding to color intensity.

Fabrication can be accomplished by any number of processes. The output can be plastic, metal, wax, wood, or any other of a variety of materials. The substrate could be flat, or the image could be overlaid on other objects of varying shapes. For instance, the painting of a boat could be placed on a surface curved as a boat hull. In this way the texture of the hull derived from the process could be presented to the user at the same time as the shape information about the hull is presented. The machine, instrument, or device for producing the 3-dimensional model might be a rapid prototyping machine, an embossing machine, or a xerographic reproducing machine.

As used herein, “tactile” and “tactilely” are used in their conventional way to convey a sense of touching something with one or more fingertips. However, tactile sense also can be conveyed by touching something with other parts of the body, such as the nose, knuckle, palm, toes, or even a stylus held between the teeth. The present invention, in its entirety, applies equally well to tactile input received from all of these body parts and modes.

Thus, a conventional photographic image of a painting (as a color or black and white photographic print, or as a slide transparency, or as a scanned, digitized image of such a painting is made directly, with an electronic camera or sensor) can be transformed into a 3-dimensional physical surface with raised, textured, relief, topographical-map-style presentation. The member is large enough (e.g., 8½″×11″) so that blind or visually impaired people or sighted people in an art museum can use the fingers of their hand to touch the textured surface and perceive the outlines and some details present in the original image. Such a surface can be fabricated from tough plastic components (or metal, glass, rubber, wood, or special paper), or by techniques of embossing, such that the final form can be washed with soap and water, or certain cleaning fluids, or autoclaved, for sanitary touching by many people. The resulting 3-dimensional objects can be perceived visually and/or tactilely.

Further, a raised-relief image (“positive’ image) figure is produced as a 3-dimensional physical object that can be hung on a wall, or displayed elsewhere, where it can be viewed visually and/or perceived tactilely. The image can be molded onto the surface of virtually any kind of material (plastic, metal, rubber, wood, paper, glass, or an edible material, such as ice cream, gelatin, or dough). An embossed image represents a positive image and can be produced by the present invention on any of the surfaces described above; the embossment can be created from dense ink, molten or monomeric plastic, rubber, or metal, and then deposited on any physical surface.

A sunken, depressed, engraved image (“negative” image) is produced that can be used as an ashtray, a bowl for nuts or salad, or any other of a variety of types of food, or for decorations. The image, as a 3-dimensional physical object, can be perceived visually and/or tactilely.

Included as program 1 is a redacted version of software for converting color intensity to height.

Thus, there has been shown and described a method and system for compressing video and resultant media which fulfills all the objects and advantages sought therefore. It is apparent to those skilled in the art, however, that many changes, variations, modifications, and other uses and applications for the method and system of compressing video and resultant media are possible, and also such changes, variations, modifications, and other uses and applications which do not depart from the spirit and scope of the invention are deemed to be covered by the invention, which is limited only by the claims which follow.

Program Code

H_V_SMTH.C

// h_v_smth.c

// 4-7-98

#include <stdio.h>

#include <conio.h>

#include <stdlib.h>

main ( )

char input_filename[80];

char output_filename[80];

char output_filename_{—}2[80];

char magic_number[10];

char comment_line[80];

int gray_levels, width, height;

int row_index, column_index;

int data_row_{—}1[600], data_row_{—}2[600];

int average_value;

int y,z;

FILE *in_file_ptr,

*out_file_ptr,

*out_file_ptr_{—}2;

printf(“\nPlease enter file name <with extension> to process\n”);

gets(input_filename);

if

((in_file_ptr = fopen (input_filename,“r”)) == NULL)

printf(“\nError opening the file”);

printf(“\nPress any key to exit”);

getch( );

exit(0);

}

// determine output pgm file name

printf(‘\nPlease enter the file name for smoothed pgm file <with extensions> \n”);

gets(output_filename_{—}2);

if((out_file_ptr_{—}2 = fopen (output_filename_{—}2,“w”)) == NULL)

{

printf(“\nError opening the smoothed pgm results file”);

printf(“\nPress any key to exit”);

getch( );

exit(0);

}

// read magic number describing file type

fgets(magic_number, 10, in_file_ptr);

printf(“\nThe file type reported is\n”);

puts(magic_number);

fputs(magic_number, out_file_ptr_{—}2);

// read comment line denoted with “#”

fgets(comment-line, 80, in-file-ptr);

printf(“\nThe comment line listing is as follows:\n”);

puts(comment_line);

fputs(comment_line, out-file-ptr-2);

// determine width and height

fscanf(in_file_ptr,“%d %d”,&width,&height);

printf(“\nThe width reported is %d and height reported is %d\n”, width, height);

// check if width exceeds array bounds

(width ==512)

{

printf(“\nFile width exceeds maximum\n”);

printf(“\nPress any key to exit”);

getch( );

exit(O);

}

// determine levels of gray of image

fscanf(in_file_ptr,“%d”,&gray_levels);

printf(“\nThe gray scale levels reported is %d”, gray_levels);

fprintf(out-file-ptr-2,“%d\n”, gray_levels);

printf(“\nPress any key to continue\n”);

getch( );

// if at this point file format is correct prompt for output file name

printf(“\nPlease enter the file name <with extension> for results\n”);

gets(output_filename);

if((out_file_ptr = fopen (output_filename,“w”)) == NULL)

{

printf(“\nError opening the results file”);

printf(“\nPress any key to exit”);

getch( );

exit(O);

}

// assume number of data points to be correct

// read and write data values

row_index = 0;

z =0;

// read first row of data values

column_index = 0;

while(column_index < width)

{

fscanf(in_file_ptr, ‘%d”, &data_row -1 [column_index]);

column_index++;

}

row_index++;

while(row_index < height)

{

column_index = 0;

while(column_index < width)

{

fscanf(in_file_ptr, “%d”, &data_row -2 [column_index]);

column_index++;

}

row_index++;

// two rows of data have been read in

// print out data value with y and z components added

y = 0;

while(y < width -1)

{

average_value = (Int) ((data_row_{—}1[y] + data_row_{—}1 [y+1] + data_row_{—}2[y] + data_row_{—}2[y+1]) /4);

fprintf(out_file_ptr, “%d %d %d\n”, average_value, y, z);

y++;

fprintf(out_file_ptr-2,“%d”, average_value);

if ((y % 75) == 0)

{

fprintf(out_file_ptr_{—}2,“\n”);

}

}

// exchange data values

y = 0;

while (y < width)

{

data_row_{—}1[y] = data_row_{—}2[y];

y++;

}

z++;

}

// conversion complete

printf(“\nConversion to a 3d horizontal <3 pixel> average format complete!!\n”);

printf(“\nPress any key to exit the program\n”);

getch( );

// close all files

fcloseall( );

// exit the program

return 0;

}

What is claimed is:

1. A method for transforming a 2-dimensional image into a 3-dimensional physical object that can be perceived tactilely, the method comprising:
(a) converting a 2-dimensional image to a digitized image whereby the image is defined by a plurality of pixels having x and y coordinates;
(b) converting the digitized image to a gray scale;
(c) assigning each pixel a z value based on the gray intensity to form a third dimension; and
(d) forming a 3-dimensional structure from the gray scale digitized image.

2. The method of claim 1, wherein the conversion to the gray scale comprises:
(a) assigning the pixels, which form the image, a gray scale level based on color intensity; and
(b) assigning a height to each pixel, based on the gray scale.

3. The method of claim 1 wherein the digitized image is filtered.

4. The method of claim 1 wherein each pixel has an x, y, and z value.

5. The method of claim 4 wherein the z value represents height.

6. The method of claim 1 wherein a the 3-dimensional structure is formed by a method selected from the group consisting of rapid prototyping, CNC format, and combinations thereof.

7. A method for transforming a 2-dimensional image into a 3-dimensional physical object that can be perceived tactilely, the method comprising:
(c) converting a 2-dimensional image to a digitized format;
(d) converting the digitized image to a gray scale;
(e) assigning each pixel a height based on the gray intensity; and
(f) forming a 3-dimensional structure from the gray scale digitized image.

8. A method for transforming a 2-dimensional image into a 3-dimensional physical object that can be perceived tactilely, the method comprising:
(a) converting an image to a digitized image whereby the image is defined by a plurality of pixels having x and y coordinates;
(b) converting the digitized image to a gray scale; and
(c) assigning each pixel a z value based on the gray intensity to form a third dimension.

9. A 3-dimensional object that can be tactilely perceived derived from a 2-dimensional picture comprising a surface of varied height, whereby height corresponds to a gray scale value and represents color intensity.

10. The object of claim 9 wherein the surface is divided into a plurality of pixels having x, y, and z values.

11. The object of claim 9 wherein the surface defines the x, y, and z coordinates.

12. A computer program for converting color intensity in a 2-dimensional image to 3-dimensional model, comprising a software program that assigns height to a 2-dimensional image based on color intensity.
